(19) United States
(12) Patent Application Publication
(10) Pub. No.: US 2018/0174483 A1
(43) Pub. Date: Jun. 21, 2018

(54) Method for Improving Sound Recognition, and Tool Improving Sound Recognition

(71) Applicant: EKAPOT BHUNACHET, Tsukuba-shi, Ibaraki (JP)

(72) Inventor: EKAPOT BHUNACHET, Tsukuba-shi, Ibaraki (JP)

(21) Appl. No.: 15/531,475

(22) PCT Filed: Dec. 3, 2015
(86) PCT No.: PCT/JP2015/084733

§ 371 Date: May 30, 2017

(30) Foreign Application Priority Data
Dec. 5, 2014 (JP) 2014-247012

(51) Int. Cl. G09B 19/06; G09B 19/04; G09B 5/04; H04R 1/10; G10K 11/20

(52) U.S. Cl. CPC G09B 19/06; G09B 19/04; G10K 11/20; H04R 1/10; G09B 5/04

(57) ABSTRACT

{Aim}

To provide the method and apparatus to restore a person's ability to recognize minute differences in words and sounds and to accurately mimic the words one hears: an ability which people possess in infancy and childhood, but usually lose as they grow up.

{Method}

In order to achieve the above aim, this invention describes a method to recognize minute differences in words and sounds by using apparatus which create a difference between the bone-conducted sound volume of the right and left ears, while keeping the volume of the air-conducted sound of the ear, with the higher bone-conducted sound volume, the same or louder than the other ear.

### TECHNICAL FIELD

This invention provides the method and apparatus to restore an adult's ability to recognize minute differences in words and sounds and to accurately mimic the words one hears, an ability which people possess in infancy and childhood, but usually lose as they grow up.

### BACKGROUND

Most people develop a foreign accent when attempting to learn a foreign language after childhood. This can be accounted for by the fact that we lose, as we grow up, the ability to distinguish minute differences in words and sounds and to accurately mimic the words we hear. (This ability which people possess in infancy and childhood will from here on be referred to as “child's ears.”) If a person's child's ears can be restored, pronunciation is bound to improve.

A person's mother tongue also has a great effect on pronunciation. For example, the Japanese language possesses an “r” sound not an “l” sound. As a result, Japanese people find it very difficult to distinguish between these two sounds.

Another cause of a foreign accent, or the inability to correct a foreign accent, is that when people are speaking, they are not able to hear what they are actually saying, i.e., the sound reflected in the air from the mouth (air-conducted sound), and the sound reflected internally through the bones (bone-conducted sound), but rather hear a conflation of the sound that the brain intends to speak,

As a practical example, in spite of a heavy accent, elite foreign students to Japan usually think that they can speak as well as Japanese. This is a common problem even among foreigners who can speak very difficult Japanese with fluency.

Also an adult Japanese born in Japan, whose facial muscles have become atrophic due to an incurable disease, does not realize that his or her Japanese pronunciation has become strange unless told by others. That is, although his or her voice has become almost incomprehensible to others, what he or she hears while speaking is their former normal pronunciation.

In order to discern the extent of one's foreign accent, recording and later listening to one's speech is an effective method. A major weakness with recording and later listening to one's speech as a method to correct pronunciation is time-lag. For example, to record one's speech in daily life and later listen to it is very time-consuming. And even if one could learn how different he or she spoke compared to native speakers through this process, it would then be necessary to record and later listen to another conversation to check whether improvement in pronunciation had taken place or not.

Up to now, there have been ear plugs and ear phones invented to improve the sound, such as those described in reference 1, but there have never been any audio apparatus that can help people recognize their real voices, not a conflation of the sound that the brain intends to speak, in real time.

### FORMER OF INVENTION

JP 2009-253488 A

### SUMMARY OF INVENTION

### Technical Problem

The aim of this invention is to provide the method and apparatus to restore an adult's ability to recognize minute differences in words and sounds and to accurately mimic the words one hears, an ability which people possess in infancy and childhood, but usually lose as they grow up.

In Japan, students commonly start learning English in junior high school and, if they continue through to the end of an undergraduate university degree, will have completed a total of ten years of English study. Despite this, most cannot speak English. Theoretically, if it was possible to restore “child's ears” to adults who, due to the effect of their mother tongue, are not able to recognize minute differences in foreign language pronunciation, many problems in foreign language conversation would be easily solved. However it has been considered impossible to restore “child's ears” once lost during a person's growth, due to changes in the brain believed to take place during this time.

Recently, the inventor has discovered that by creating a difference between the bone-conducted sound volume of the right and left ears, and at the same time keeping the volume of the air-conducted sound of the ear with the higher bone-conducted sound volume the same or louder than the other ear, one can hear what he or she is actually saying, not just the sound that the brain intended to speak.

The 51 year-old inventor, has lost his “child's ears” just like other people. His mother tongue is Thai. In order to check whether he could accurately pronounce Japanese or English words he heard, it was necessary to record and replay his own voice. However after utilizing the method, which will later be described in detail, to create a difference between the bone-conducted sound volume of the right and left ears, while keeping the volume of the air-conducted sound of the ear, with the higher bone-conducted sound volume, the same or louder than the other ear, he was able to recognize, in real time, whether there he was speaking with an accent or not.

Though further research and verification is required to determine the reason for this phenomena, the inventor hypothesizes that during infancy and childhood, the hearing ability of the left and right brain develop unequally.

For example, consider the scenario where the hearing ability of the left ear develops more quickly than the right. In this case, both bone-conducted hearing and air-conducted hearing would be stronger in the left side than the right side throughout infancy and childhood. Under this condition, infants and children could recognize minute differences in words and sounds and accurately mimic the words they hear. But this ability (child's ears) would be lost as the hearing of the right ear developed to the same level as that of the left.

This may be the reason why adults who have lost their child's ears can recover this ability by creating a difference between the bone-conducted sound volume of the right and left ears, while keeping the volume of the air-conducted sound of the ear, with the higher bone-conducted sound volume, the same or louder than the other ear. Based on this phenomena, the inventor has developed the following inventions:

### Solution to the Problem

(1) A method to improve recognition of minute differences in words and sounds, by creating a difference between the bone-conducted sound volume of the right and left ears, while keeping the volume of the air-conducted sound of the ear, with higher bone-conducted sound volume, the same or louder than the other ear.
(2) Apparatus to improve recognition of minute differences in words and sounds, by creating a difference between the bone-conducted sound volume of the right and left ears, while keeping the volume of the air-conducted sound of the ear, with higher bone-conducted sound volume, the same or louder than the other ear.
(3) Apparatus to improve recognition of minute differences in words and sounds composed of one ear plug made of material with high ventilation and sound reflection, and a second ear plug made of material with lower ventilation and sound reflection than the first. Placing these ear plugs in the ears thereby creates a difference between the bone-conducted sound volume of the right and left ears, while keeping the volume of the air-conducted sound of the ear, with higher bone-conducted sound volume, the same or louder than the other ear.
(4) Apparatus to improve recognition of minute differences in words and sounds composed of one earphone whose sound is modified using material with high ventilation and sound reflection, and a second earphone whose sound is modified using material with lower ventilation and sound reflection than the other earphone. Placing these earphones in both ears thereby creates a difference between the bone-conducted sound volume of the right and left ears, while keeping the volume of the air-conducted sound of the ear, with higher bone-conducted sound volume, the same or louder than the other ear.
(5) Apparatus to improve recognition of minute differences in words and sounds composed of one headphone whose sound is modified using material with high ventilation and sound reflection and a second headphone whose sound is modified using material with lower ventilation and sound reflection than that of the other headphone. Placing these earphones in both ears thereby creates a difference between the bone-conducted sound volume of the right and left ears, while keeping the volume of the air-conducted sound of the ear, with higher bone-conducted sound volume, the same or louder than the other ear.
(6) Apparatus to improve recognition of minute differences in words and sounds composed of left and right parts made of materials with different sound reflection; designed so that the part made of material with lower sound reflection is more airtight when inserted into the ear than the other. Placing left and right parts into the respective ears thereby creates a difference between the bone-conducted sound volume of the right and left ears, while keeping the volume of the air-conducted sound of the ear, with higher bone-conducted sound volume, the same or louder than the other ear.
(7) Audio apparatus composed of at least one sound-recognition-improving product made according to the specifications of any of the claims 2 to 6, and at least one microphone through which the user of this apparatus can hear their own voice.

### Advantageous Effects of the Invention

By using the sound-recognition-improving method and apparatus of this invention, one can restore the ability to recognize minute differences in words and sounds and to accurately mimic the words one hears.

As a result, the problems Japanese face in studying English for years and still not being able to speak English, or the problems immigrants to America face in not being able to find jobs because of poor English, will easily be solved.

### DESCRIPTION OF EMBODIMENTS

The invention can be more clearly understood with reference to the following examples. However, it should be emphasized that this invention is not limited to these examples.

Before introducing these examples, it is important to understand two kinds of sound: bone-conducted sound and air-conducted sound.

When people speak, they hear their voice through two means: bone-conduction and air-conduction. In air-conduction, sounds are transmitted through the vibration of air through the ear canals to the ear drums, which then transfer the vibrations to the acoustic nerve (internal ear). On the other hand, in bone-conduction, the vibration of the vocal cords is transmitted through the skull directly to the acoustic nerves. The transmission of sound via bone-conduction occurs unintentionally. For example, when people hear their own voice, they are actually hearing a combination of air-conducted and bone-conducted sounds. As a result, people usually feel strange, when listening to a recording of their own voice, since the recording of their voice using a microphone only picks up the air-conducted sound.

### EXAMPLES

### Example 1

If one plugs their left ear for example, by covering it with his or her hand, and then says something, the volume heard by the left ear is greater than the right because the bone-conducted sound volume of the left ear is amplified. However, by doing so, while the bone-conducted sound volume of the left ear is amplified, the air-conducted sound is blocked and therefore its volume is reduced. Under this condition, child's ears are not restored.

How, then, can one amplify the bone-conducted sound volume of the left ear, and at the same time, keep the bone-conducted sound volume of the left ear the same or higher than that of the right ear? This can be done by inserting a small sponge in the left ear and some tissue paper in the right ear.

By making sounds like “uh” or “ah” with the mouth closed, it is clear that the sound heard in the left year is louder than that of the right because the tissue paper absorbs more sound than the sponge. As a result, the sound conducted through the skull and resonating in the ear canal is smaller in the ear plugged with tissue paper than the ear plugged with sponge. Next the effect on regular speech with the mouth open can be tested under the same conditions. It can be seen that the sound in the left ear is still louder than the right. This is because the holes in the tissue paper are much smaller than those of the sponge, and thus the transmission of air vibration to the ear drum is more hindered.

By plugging one ear, for example the left ear, with sponge, and the right ear with tissue paper, both the bone-conducted and air-conducted sound volume of the left ear will be higher than those of the right ear. In this condition, even adults are able to recover their “child's ears.” That is, they can learn to converse in foreign languages without the influence of their mother tongue.

In Japan, the government considers it essential to educate its people to be able to work internationally. As a result, legislation has been passed to begin English language education from the upper elementary school grades instead of in middle school as is currently the practice.

However, if the method of English education does not change, even if English is taught from the first grade of primary school, the problem of English spoken with a heavy Japanese accent will not be solved. In the example of India, even though English has been adopted as an official language and is used to teach all school subjects, Indian people still speak with an accent. The same can be said for Singapore, Malaysia and the Philippines.

Using the present invention, this problem of a foreign accent will be solved. For example, during English class, students could be asked to insert a sponge ear plug in their left ear, and an ear plug made of a material like tissue paper in their right ear. In this way problems in conversation would be eliminated. Students will be able to hear their own voice and that of others clearly.

Then, if students are asked to listen and repeat the recorded words or conversations of native English speakers, since their child's ears have been restored, they will be able to recognize and properly mimic the details of American English pronunciation. Students will memorize their actual pronunciation and since they can correctly mimic the recordings of native English speakers, their pronunciation will not differ from Americans. At that point, the development of their fluency in English conversation will depend on the amount of English vocabulary and grammar they are able to absorb.

Currently in Japan there are many students that hate studying English because their pronunciation is so poor, and even if they do speak, they can't make themselves understood. There are also many scientists who can read complex research papers in English, but remain poor at English conversation. These kinds of problems will be solved by applying the present invention to English education.

Although in the above description, sponge and tissue paper were suggested to plug the ears, this invention is by no means limited to these materials. In addition, while the present invention has great application for foreign language education, it can also have great benefit in music education, for instance singing in one's native language.

### Example 2

In the first example, sponge was used to plug the left ear, and tissue paper was used to plug the right, in order to make both the bone-conducted and air-conducted sound volume of the left ear higher than those of the right. In the second example, it will be illustrated how earphones and headphones can be used to achieve the same result.

Inserting an earphone into an ear will increase the bone-conducted sound and reduce the air-conducted sound. Typically both earphones are made uniformly and are often covered with a thin sponge material. Under these conditions, the air-conducted sound of both ears is uniformly reduced and the bone-conducted sound is uniformly increased. As a result, there is no difference in the sound volume heard by the left and right ears.

If however, instead of using sponge, the right side for example, was covered with very firm cloth, then the bone-conducted sound volume of the right ear will be reduced, similar to the ear being plugged with tissue paper. Using cloth, which is thicker than the sponge covering the left earphone, and also more airtight, makes the volume of the right earphone higher in comparison. As a result, the air-conducted sound is more hindered in the right ear than in the left.

Under these conditions, one hears one's own voice louder in the left ear regardless of whether the sound was made with the mouth open or closed. In this way, one can hear what he or she is actually saying, not just what the brain intends to say.

With headphones, when the headphone pad covers the ear, the bone-conducted sound is emphasized and the air-conducted sound is reduced. Typically both sides of the headphones are made of the same materials and have the same structure. Under these conditions, the air-conducted sound of both ears would be uniformly reduced and the bone-conducted sound would be uniformly increased.

However, if a sponge-type material was used to plug the depression in the headphone pad on, for example, the left side, and a material with properties similar to tissue paper was used to plug the depression in the headphone pad on the right side, both the bone-conducted sound volume and the air-conducted sound volume of the left ear can be kept higher than that of the right ear, achieving a similar result to the first example.

Incidentally, as long as there is no sound output from the headphones, there is little impact on daily conversation. So whether using the earplugs from the first example, or the headphones from the second example, the goals of this invention can be achieved without speaker function.

Recently, most earphones are designed with one big hole rather than many small holes as in the past. In that case, they would need to be modified similar to the headphones in the example above. That is, by inserting a sponge-like material into the hole of, for example, the left earphone, and inserting a material with properties similar to tissue paper into the hole of the right earphone, the volume of the bone-conducted sound and air-conducted sound for the left ear can be maintained higher than those of the right ear.

Of course, headphones could be manufactured with the properties described in the above example modifications. So, for example, the left earphone or headphone could be built from high sound-reflecting material, and the right earphone or headphone of low sound-reflecting material, thus making the right earphone or headphone more airtight to the ear canal than the left, while keeping the volume of the bone-conducted sound and air-conducted sound of the left ear larger than that of the right.

Suppose a person uses earphones or headphones made or modified according to the present invention, thus keeping the volume of both the bone-conducted sound and air-conducted sound of, for example, the left ear higher than that of the right. If he or she were then to listen to an English conversation recording, set such that the left speaker volume is higher than the right, then the user would be able to confirm the accuracy of their pronunciation while repeating recorded words and phrases. On the other hand however, if the right speaker volume is set higher than the left, then the user would not be able to confirm the accuracy of their pronunciation while listening to the recording. While the recording is playing the user cannot accurately hear their own pronunciation but when it is stopped they can.

Using earphones and headphones made or modified according to the present invention as described above, connected to an audio player with a karaoke function (i.e. functionality to allow someone to hear his or her voice as projected through a microphone while also listening to a sound recording), would help solve the problem of difficulty in hearing one's own voice due to the use of earphones or headphones. With this functionality, it is convenient to practice a foreign language outdoors. Users can check their pronunciation against the recording they are listening to, simply by whispering softly into the microphone.

When combined with an audio player with karaoke functionality, the present invention is expected to achieve major improvements in singing practice also. There is a YouTube video of a man singing along with a song that he is listening to through earphones (https://www.youtube.com/watch?v=zTQABTj8Z7Y&spfreload=1). In the first half of the video, the man can be seen singing but only the audio track of the song played in his headphones can be heard. According to the man, he imagined himself being able to sing as well as the recording, but the reality is quite different. In the second half of the video, the same scene is shown but this time only the man's real voice can be heard. Suddenly it is very clear how bad a singer he is.

Like the man in this video, people, who have no ear for music, usually cannot judge for themselves whether they can sing properly or not. In the same way, adults, who have lost their child's ears, cannot recognize the extent of their accent when speaking a foreign language.

Using earphones and headphones made or modified according to the present invention, even people without an ear for music will be able to recognize in real time how accurately they are singing in comparison to a recording, and finally overcome this problem. The present invention will also help people, who do have an ear for music, judge whether they are properly mimicking the professional techniques of the singer. Considering these benefits, karaoke bars can expect more customers if they provide earphones or headphones, made or modified according to the present invention, for customers to use when singing.

Incidentally, it is not necessary to use a pair of earphones or headphones to achieve the goals of the present invention. For example, an earphone or headphone which raises the bone-conducted sound level for the left ear, and an earplug, made from material with similar properties to tissue paper, to decrease the bone-conducted sound level of the right ear below the left, would be very effective. In this scenario, the air-conducted sound level of the left ear could be kept higher than that of the right, by amplifying one's voice through a microphone to the earphone or headphone of the left ear.

1. A method to improve recognition of minute differences in words and sounds, by creating a difference between the bone-conducted sound volume of the right and left ears, while keeping the volume of the air-conducted sound of the ear, with higher bone-conducted sound volume, the same or louder than the other ear.

2. Apparatus to improve recognition of minute differences in words and sounds, by creating a difference between the bone-conducted sound volume of the right and left ears, while keeping the volume of the air-conducted sound of the ear, with higher bone-conducted sound volume, the same or louder than the other ear.

3. Apparatus to improve recognition of minute differences in words and sounds composed of one ear plug made of material with high ventilation and sound reflection, and a second ear plug made of material with lower ventilation and sound reflection than the first. Placing these ear plugs in the ears thereby creates a difference between the bone-conducted sound volume of the right and left ears, while keeping the volume of the air-conducted sound of the ear, with higher bone-conducted sound volume, the same or louder than the other ear.

4. Apparatus to improve recognition of minute differences in words and sounds composed of one earphone whose sound is modified using material with high ventilation and sound reflection and a second earphone whose sound is modified using material with lower ventilation and sound reflection than the other earphone. Placing these earphones in both ears thereby creates a difference between the bone-conducted sound volume of the right and left ears, while keeping the volume of the air-conducted sound of the ear, with higher bone-conducted sound volume, the same or louder than the other ear.

5. Apparatus to improve recognition of minute differences in words and sounds composed of one headphone whose sound is modified using material with high ventilation and sound reflection and a second headphone whose sound is modified using material with lower ventilation and sound reflection than that of the other headphone. Placing these earphones in both ears thereby creates a difference between the bone-conducted sound volume of the right and left ears, while keeping the volume of the air-conducted sound of the ear, with higher bone-conducted sound volume, the same or louder than the other ear.

6. Apparatus to improve recognition of minute differences in words and sounds composed of left and right parts made of materials with different sound reflection; designed so that the part made of material with lower sound reflection is more airtight when inserted into the ear than the other. Placing left and right parts into the respective ears thereby creates a difference between the bone-conducted sound volume of the right and left ears, while keeping the volume of the air-conducted sound of the ear, with higher bone-conducted sound volume, the same or louder than the other ear.

7. Audio apparatus composed of at least one sound-recognition-improving product made according to the specifications of any of the claims 2 to 6, and at least one microphone through which the user of this apparatus can hear their own voice.
